(19) United States
(12) Patent Application Publication
(10) Pub. No.: US 2005/0140515 A1
(43) Pub. Date: Jun. 30, 2005

(54) Fire suppression system

(76) Inventor: Clive David Goodchild, Rochester, Kent (GB)

Correspondence Address: CROWELL & MORING LLP;INTELLECTUAL PROPERTY GROUP, P.O. BOX 14300, WASHINGTON, DC, 20044-4300, US

(21) Appl. No.: 10/504,365

(22) PCT Filed: Feb. 20, 2003
(86) PCT No.: PCT/GB03/00736

(30) Foreign Application Priority Data
Feb. 26, 2002 (GB) 0204361.0

(51) Int. Cl. G08B 17/00

(52) U.S. Cl. 340/584; 340/693.9

(57) ABSTRACT

Described herein is a temperature sensing device in the form of a fastener arrangement (10). The arrangement (10) comprises a bolt assembly (12), a nut assembly (14) and a sensor assembly (16) located within the bolt assembly (12). The sensor assembly (16) connects with a processing module (24) mounted in the nut assembly (14) which processes signals received from the sensor assembly (16). The fastener arrangement (10) operates to hold a liner panel (18) against a bracket (20) as well as sensing temperature in its vicinity. A connector (26) is provided on the nut assembly (14) for connecting with a control system. The fastener arrangement (10) may form past of a fire detection or fire detection and suppression system.

The present invention relates to improvements in or relating to fire detection and suppression systems, and is more particularly, although not exclusively concerned with the utilisation of such systems on aircraft.

There is an increasing trend in the number of false aircraft cargo alarms. The ratio of false alarm events to actual fire or smoke events is also increasing and is typically of the order of 200 to 1;

In addition, the environmental concerns regarding stratospheric ozone layer protection has led to the production of Halon and other chlorofluorocarbons (CFCs) being phased out and hence their use as fire suppression agents. This means that other fire suppression agents need to be developed.

In aircraft, water mist fire suppression systems are now being introduced as replacements for CFC-based fire suppression systems. However, water-based systems carry a substantial weight penalty, and the weight of water needs to be reduced to a minimum.

U.S. Pat. No. 5,038,867 discloses a system for use in the freight and cargo space of aircraft for fire protection and for extinguishing a fire in such a space. The system comprises two containers which hold fire extinguishing media, for example, media which are liquid under pressure and become gaseous at atmospheric pressure. The system is initialised and triggered by smoke detection in the freight and cargo space and is operated by the aircraft pilot using a trigger switch. Operation of the trigger switch ruptures a safety membrane in one of the two containers in accordance with the location of the fire within the freight and cargo spaces. The fire extinguishing medium then flows from the container into a conduit network which distributes the medium to nozzles in the locality of the fire so that the fire is rapidly extinguished. If necessary, the medium in the other container can also be directed into the same conduit network for deployment through the same nozzles.

However, U.S. Pat. No. 5,038,867 is still prone to generating false alarms and the freight or cargo being transported may be damaged by the unnecessary use of the fire extinguishing media.

U.S. Pat. No. 4,423,326 discloses a fire or explosion detection system which can discriminate between radiation produced by a source of fire or explosion (e.g. a hydrocarbon fire) and radiation produced by a source which is not detected (e.g. an incendiary ammunition or pyrophoric reaction). The system comprises two detectors connected to a processor, each detector being sensitive to radiation in different wavelength bands, for example, respective narrow wavelength bands centred at 0.96 μm and 4.4 μm. The output from each detector is thresholded and passed to an AND gate. A third input to the AND gate is provided by a signal derived from the rate of change of one of the detector outputs when compared with a reference signal. When the AND gate receives three binary “1” signals, the output of the AND gate changes from binary “0” to binary “1” and if it is maintained for a predetermined period of time, fire or explosion suppression is initiated.

U.S. Pat. No. 6,195,011 discloses an early fire detection system which operates in a similar way to U.S. Pat. No. 4,423,326. This system senses two physical quantities relating to a fire, for example, smoke and temperature. When the first physical quantity (smoke) is detected, it is compared to a threshold value. If the threshold is exceeded an alarm condition is set. Similarly, an alarm condition is set when the second physical quantity (temperature) exceeds a threshold value. Further alarm conditions may be set corresponding to rate of change of one or more of the physical quantities and the combined rate of change of both physical quantities. The alarm is triggered in response to a cross-correlation of the set alarm conditions.

Both U.S. Pat. No. 4,423,326 and U.S. Pat. No. 6,195,011 utilise at least a two stage detection method prior to triggering operation of a fire suppression system.

It is well known to use thermocouple devices for sensing temperature. U.S. Pat. No. 4,904,091 shows a threaded average temperature thermocouple in which a thermocouple is located within a threaded bolt made of a material whose thermal properties are similar to those of material whose temperature is to be sensed. This relies on selecting the correct material for the bolt in order to effectively sense the temperature of a body.

U.S. Pat. No. 3,765,242 discloses a re-usable bolt type mounted thermocouple in which the mounting is slotted lengthwise to allow the thermocouple to be replaced and the mounting to be re-used.

It is one object of the present invention to provide an improved fire detection and suppression system.

It is a further object of the present invention to provide an improved sensing element for use in the improved fire detection and suppression system.

In accordance with one aspect of the present invention, there is provided a temperature sensing device comprising:
a bolt assembly;
a nut assembly mountable on the bolt assembly;
a sensor assembly located within the bolt assembly; and
a processing assembly located within the nut assembly, the processing assembly being connectable to the sensor assembly to process signals generated by the sensor assembly in response to temperature.

Advantageously, the processing assembly includes an electronics module and means for connecting the electronics module to a remote control unit. The electronics module is capable of storing a unique identification code for the device. The unique identification code may be determined in accordance with the location of the device with respect to a reference position.

Preferably, the processing assembly includes at least one indicator unit connected to the electronics module for indicating the operational status of the device. Said at least one indication unit comprises a light emitting diode. Preferably, two light emitting diodes are present, one green and one red.

The sensor assembly may comprise a sensor element having a connector portion for connecting with the processing assembly. Ideally, the sensor element comprises a thermocouple, but may comprise a semiconductor temperature sensing element. In either case, the sensor element is preferably mounted in a sheath within the bolt assembly. Advantageously, the sheath comprises a light pipe which transmits light from said at least indicator unit to an external surface of the device, for example, a head portion of the bolt assembly.

In accordance with a second aspect of the present invention, there is provided a fire detection system comprising:
at least one first detector for detecting the presence of smoke;
at least one second detector for detecting the presence of elevated temperatures; and
processing means connected each of said at least one first and second detectors for receiving signals therefrom indicative of the presence of smoke and elevated temperatures respectively, and for producing an indication of the presence of a fire;
characterized in that each of said second detector means comprises a temperature sensing device as described above.

Preferably, the processing means includes first comparison means for determining if the signals from said at least one first detector exceeds a first predetermined threshold, and second comparison means for determining if the signals from said at least one second detector exceeds a second predetermined threshold, the second comparison means being enabled by an output signal from the first comparison means when the first predetermined threshold is exceeded and produces the indication of the presence of a fire when the second predetermined threshold has been exceeded.

In accordance with a third aspect of the present invention, there is provided a fire suppression system comprising:
a fire detection system as described above;
fire suppression means for suppressing a fire;
control means for controlling the fire suppression means once a signal corresponding to the indication of the presence of the fire has been input.

Advantageously, the control means includes comparison means connectable to said at least one second detector for receiving signals therefrom, the comparison means determining if a predetermined threshold has been exceeded and provides a control signal for operating the fire suppression means. It is preferred that the comparison means receives signals from a plurality of second detectors whose signals have exceeded the second threshold in the second comparison means and provides control signals for the fire suppression means in the locality of said plurality of second detectors.

Preferably, the fire suppression means comprises a water mist system utilising a plurality of nozzles.

For a better understanding of the present invention, reference will now be made, by way of example only, to the accompanying drawings in which:

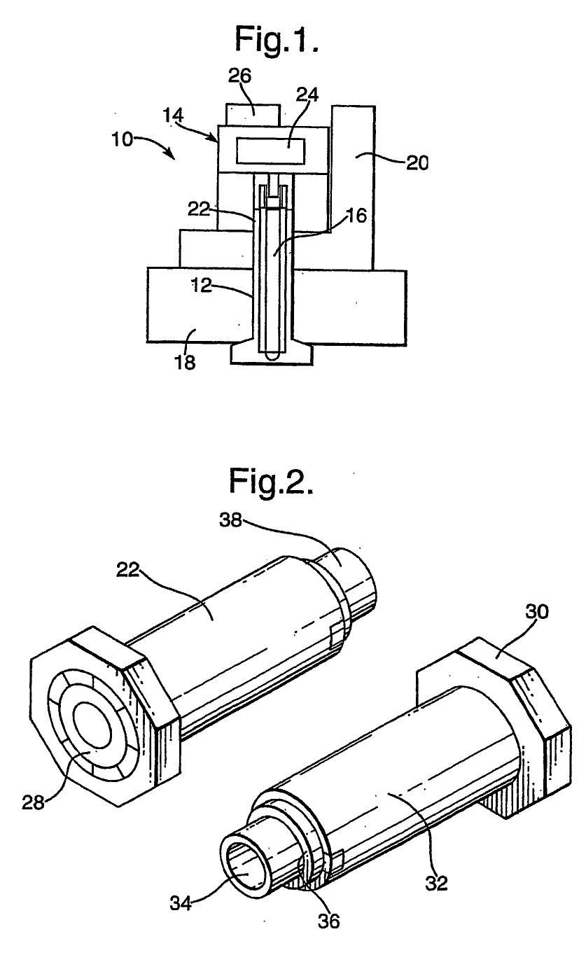

FIG. 1 illustrates a fastener arrangement in accordance with the present invention;

FIGS. 2 to 5 illustrates components of the fastener arrangement of FIG. 1;

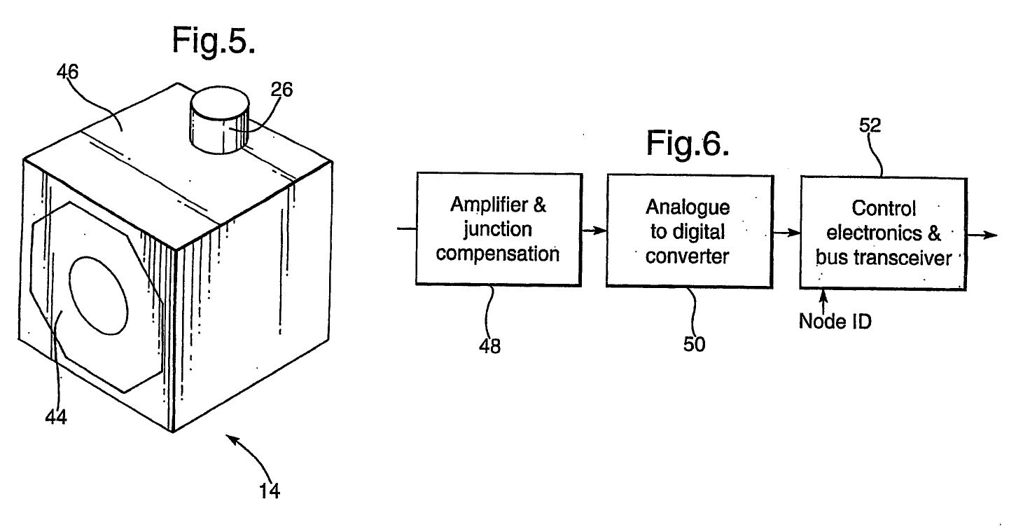

FIG. 6 illustrates the electronics associated with the nut assembly of FIG. 5;

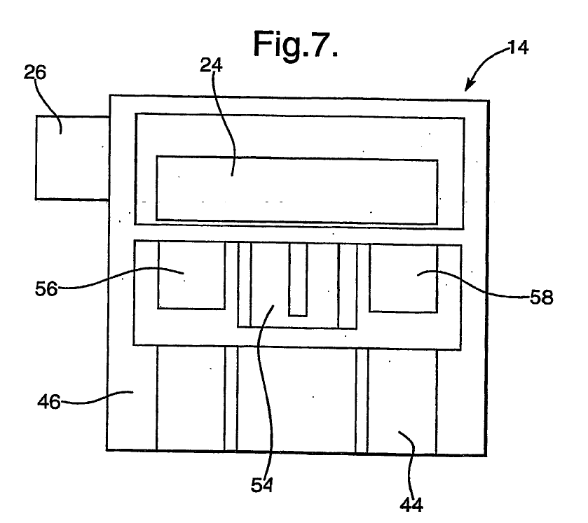

FIG. 7 illustrates the nut assembly if FIG. 5 in more detail;

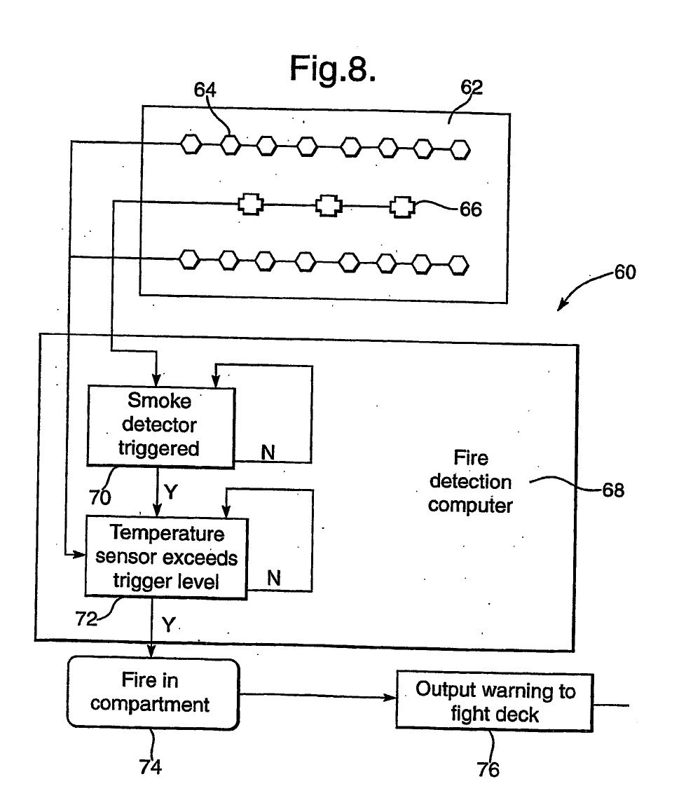

FIG. 8 illustrates a fire detection system employing the fastener arrangement of FIG. 1;

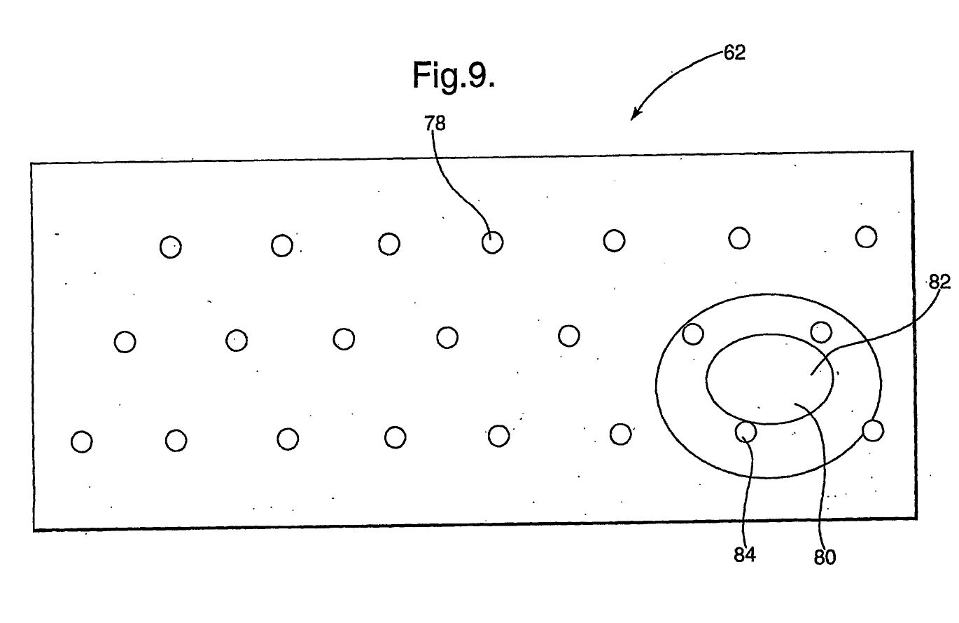

FIG. 9 illustrates fire suppression zone control in accordance with the present invention; and

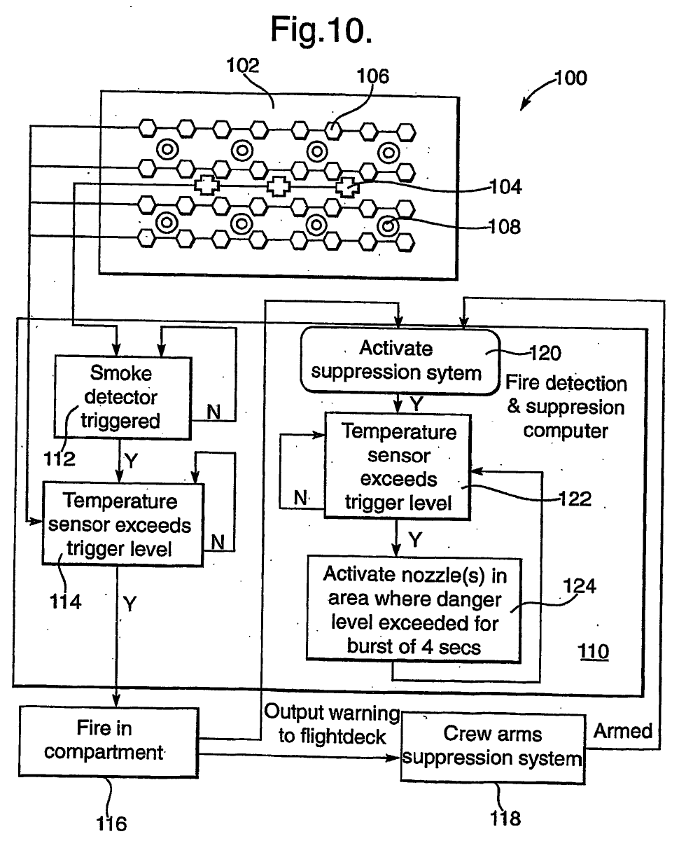

FIG. 10 illustrates a fire detection and suppression system in accordance with the present invention.

The present invention relates to a water mist fire suppression system for aircraft cargo bay compartments which utilises a new fastener. The fastener is modular and can be constructed to fit all aircraft variants, and it serves the purposes of holding an aircraft cargo bay liner panel in situ and providing temperature detection thereby allowing the control of the water mist fire suppression system of which it forms a part.

Although the present invention will be described with reference to an aircraft cargo bay fire suppression system and a thermocouple sensor, it will be readily appreciated that the fire suppression system can be employed in other applications, and alternative temperature sensing elements could be employed which meet fastener constraints.

Turning now to FIG. 1, here a fastener arrangement 10 is shown. The arrangement 10 comprises a bolt assembly 12, a nut assembly 14 and a removable or integrated temperature sensor assembly 16. The bolt assembly 12, the nut assembly 14 and the sensor assembly 16 will be described in more detail below.

As shown in FIG. 1, the bolt assembly 12 is utilised to retain a portion 18 of a cargo bay liner panel against a bracket 20, in conjunction with the nut assembly 14.

As shown, the bolt assembly 12 houses part of the sensor assembly 16 within a hollow bolt 22. The sensor assembly 16 connects with an electronics module 24 housed in the nut assembly 14. A connector 26 is provided on nut assembly for connecting to a control system (not shown).

The bolt assembly 12 includes a hollow bolt 22 which provides an aperture for the sensor assembly 16, and is shaped at its head end to allow water to drip off. It is preferred that the head end be coated with a material which reduces water surface tension and prevents water collection on its surface. As mentioned above, the bolt assembly 12 functions to retain a cargo bay liner panel 18 in position. However, the nut assembly 14 is required to hold the bolt assembly 12 in place thereby retaining the cargo bay liner panel 18.

The nut assembly 14 houses the electronics module 24 which processes the signals received from the sensor assembly 16. The module 24 includes a bus transceiver for data transmission between the fastener arrangement 10 and any control system (not shown) to which it is connected. The module 24 also includes built-in test and electronic identification as will be described in more detail below. The nut assembly 14 may also include one or more light emitting diodes (LEDs).

The sensor assembly 16 includes a temperature sensor which provides fire detection monitoring for the system (not shown) with which the fastener arrangement 10 is associated. It may include a transparent insulator around a sensor element which also acts as a light pipe to allow the operational status of the sensor element to be indicated through illumination from the nut assembly 14.

FIG. 2 illustrates the bolt assembly 14 with the sensor assembly 16 located within it. As shown, the bolt 22 houses the sensor assembly 16 such that a sensor element 28 extends the length of the bolt 22 but is present at the surface of head portion 30 of the bolt 22 and extends beyond the end of shank portion 32. Sensor element 28 comprises a thermocouple 34 located within a light pipe 36 and has a connector portion 38 formed in the exposed end of the thermocouple 34.

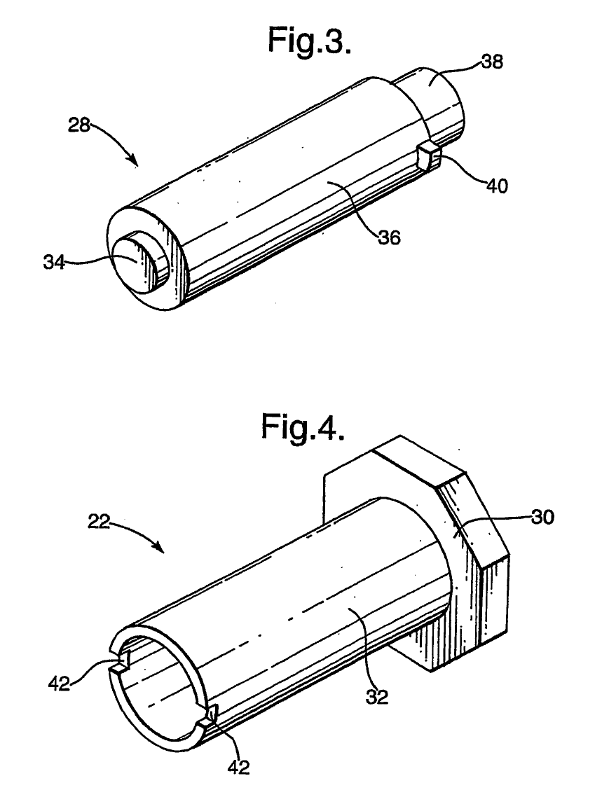

FIG. 3 illustrates the sensor element 28 in more detail. Components which have been previously described are referenced the same. As shown in FIG. 3, the thermocouple 34 extends beyond the light pipe 36 in which it is mounted at both ends. One end of the light pipe 36 includes two locating pegs 40 (only one of which can be seen) which locates in slots formed in the hollow shank portion 32 (FIG. 2) of the bolt 22. The end of the thermocouple 34 has a connector portion 38 formed in it which extends beyond the bolt 22 and engages with connections in the nut assembly 14.

FIG. 4 illustrates the bolt 22 and, in particular, slots 42 formed in the edge of shank portion 32 of bolt 22. The head portion 30 of the bolt 22 is selected so that a) it minimises water collection; b) the sensor assembly 18 is not damaged during assembly; and c) a standard nut runner can be used to screw the bolt assembly 12 into the nut assembly 14. The head portion 30 may also be selected so that it is easily distinguished from the rest of the cargo bolts holding the cargo bay liner panel in place.

Naturally, the bolt 22 has mechanical integrity with an equivalent fixture which has a hole extending through the middle thereof.

FIG. 5 illustrates the nut assembly 14, and comprises a nut portion 44 for retaining the bolt 22 in place, and electronics module 24 for processing data received by the thermocouple 34 and for transmitting the data to a control system (not shown) via a data bus connection (also not shown).

The electronics module 24 and nut portion 44 are mounted in a housing 46, and as mentioned above, a connector 26 is provided on the housing 46 of the nut assembly 14 for connecting to the control system (not shown).

A suitable connector (not shown) is also present in the housing 46 for connecting with the connector 38 of the sensor element 28 of the sensor assembly 16 once the nut assembly 14 has been attached onto the bolt assembly 12 via nut portion 44 and shank portion 32. It will be appreciated that at least a portion of the shank portion 32 of the bolt 22 is threaded so as to receive nut portion 44 thereon.

The connector is also connected to the electronics module 24 for supplying signals thereto from the thermocouple 34.

The electronics module 24 includes a thermocouple amplifier and junction compensation unit 48 coupled to an analogue-to-digital (A/D) converter 50. The amplifier/compensation unit 48 amplifies the signals received from the thermocouple 34 and passes them to the A/D converter 50 where they are digitised for passing to control electronics/bus transceiver unit 52. The control electronics/bus transceiver unit 52 also includes a built in test system (BIT) and programmable electronic identification. A standard serial aircraft data bus chip set may be used as the bus transceiver and a field programmable gate array (FPGA) may act as BIT and control electronics of unit 52. The BIT function provides information relating to whether the sensor assembly 16 is operating within prescribed limits or has failed.

The unit 52 may also include an electrical erasable programmable read only memory (EEPROM) as a memory for electronic identification of the sensor assembly 16. The EEPROM can be programmed via the bus transceiver.

The unit 52 may be implemented as a surface mount double sided printed circuit board (PCB) or in a mixed analogue and digital gate array.

LEDs may also be included in nut assembly 14 as shown in FIG. 7. As before, components which have been described above are referenced the same. In FIG. 7, a connector 54 is shown for connecting the sensor assembly 16 to the electronics module 24, and two LEDs 56, 58 which are used to indicate the operational status of the sensor assembly 16. The connector 54 makes contact with connector 38 of the sensor element 28 in any suitable way which allows the transfer of signals from the thermocouple 34 to the electronics module 24.

As the thermocouple 34 is housed in a light pipe 36, the light from the LEDs 56, 58 can be transmitted from the nut assembly 14 to the head portion 50 of the bolt 22 via the light pipe 36 to provide an indication to maintenance personnel of the operating status of the sensor assembly 16. The light pipe 36 also acts as a sheath to protect the thermocouple 34 from damage, insulates the sensor or thermocouple 34 from the bolt 22, and provides mechanical strength to the sensor assembly 16.

A fire detection system in accordance with the present invention will now be described with reference to FIG. 8. FIG. 8 shows a fire detection system 60 which comprises a plurality of sensors 64, 66 located in a cargo bay compartment 62 and a fire detection computer 68 connected to the sensors 64, 66, the computer 68 producing an output 74 indicative of a fire in the cargo bay compartment 62 when certain conditions have been met, the output 74 being connected to a warning 76 on the flight deck of the aircraft.

Sensors 66 are smoke detectors as are well known in the field, and provide output signals to a smoke discriminating unit 70 in the computer 68.

The sensors 64 are fastener arrangements as described above with particular reference to FIG. 1. The sensors 64 are connected to a temperature discriminating unit 72 in the computer 68.

In operation, the computer 68 continuously receives signals from sensors 64, 66 but output 74 is not initiated until certain conditions have been met. When smoke is detected by sensors 66 in the cargo bay compartment 62, signals are provided to smoke discriminating unit 70 and when the signals reach a threshold or trigger level an output signal is provided to the temperature discriminating unit 72. At the same time as smoke is being detected by sensors 66, sensors 64 are detecting temperature in the cargo bay compartment 62. The output signal from the smoke discriminating unit 70 enables signals from sensors 64 to be compared to a threshold or trigger level. Once the threshold or trigger level has been achieved, the temperature discriminating unit provides output 74 indicating that a fire is present in the compartment 62. The output 74 is passed as a warning 76 to the flight deck where appropriate action is taken to extinguish the fire.

The sensors 64, 66 are arranged in a suitable grid within the compartment 62 and each sensor is connected to a signal bus for transferring signals from each sensor 64, 66 to respective ones of the smoke and temperature discriminating units 70, 72 as shown.

It will readily be understood that the fire detection system 60 is a two stage or two layer system which requires two separate events to occur prior to triggering the warning signal. It is possible that the warning signal itself may be used to activate fire extinguishing or fire suppression equipment.

It is known to use water as a fire extinguishing agent, but as discussed above the quantity of water which is needed to tackle the fire has a serious weight disadvantage if the water is to be used in a flooding system, that is, if all the nozzles are turned on in the cargo bay compartment. Water weight can be reduced by only activating nozzles where the fire threat is located. This is shown in FIG. 9.

FIG. 9 shows a cargo bay compartment 62 in which a plurality of water nozzles 78 are located. A fire is located in an area 80 and a fire control zone 82 surrounds the area 80. Here, only four nozzles 84 are activated to suppress or extinguish the fire. In this arrangement, it is necessary to measure the temperature at a sufficiently small grid spacing to determine if a nozzle is to be activated or not.

Water weight can be further reduced if the nozzles are only activated in bursts when the temperature exceeds a predetermined level. In such a system, the fastener arrangements 10 will need to be spaced in a grid. Furthermore, if the water is applied as a directed fine mist even less water is required.

A fire suppression system 100 utilising the fire zone control of FIG. 9 is shown in FIG. 10. In FIG. 10, a cargo bay compartment 102 includes a plurality of smoke detectors 104, a plurality of temperature sensors 106 and a plurality of water nozzles 108. As shown, the smoke detectors 104 are located centrally within the compartment 102, and the temperature sensors 106 are arranged in a grid around the water nozzles 108. In the embodiment shown, there are four temperature sensors 106 for each water nozzle 108. It will, however, be appreciated that any other suitable number of temperature sensors 106 can be associated with each water nozzle 108. Similarly, any suitable number of smoke detectors 104, temperature sensors 106 and nozzles 108 can be provided in the compartment 102.

The sensors 104, 106 are connected to a fire detection and suppression computer 110 which determines if there is a fire and suppresses the fire when armed by the aircraft crew. The computer 110 includes a smoke discriminating unit 112 which determines if the level of smoke in the compartment 102 exceeds a threshold or trigger level, and provides an output signal for a temperature discriminating unit 114 when the threshold or trigger level has been exceeded. The temperature discriminating unit 114 is connected to the temperature sensors 106 in the compartment 102 and receives signals therefrom indicative of elevated temperatures at one or more locations within the compartment 102. When the temperature in one or more location exceeds a threshold or trigger level, an output signal 116 is provided indicative of the presence of fire in the compartment 102 and the location(s) of the fire within the compartment 102. This is similar to the fire detection system 60 as previously described with reference to FIG. 8.

The output signal 116 is used to alert the crew via a warning on the flight deck and the crew then arms the fire suppression system as shown by block 118. Arming the fire suppression system provides an input to the computer 110 and initiates activation of the suppression system (box 120). The output signal 116 is also fed directly to box 120 so that the location of the fire is available for the suppression system. Once activated, a further temperature discriminating unit 122 determines if a threshold or trigger level has been exceeded. If it has, an output signal is provided to nozzle activation unit 124 which activates the nozzles 108 in one or more areas where the threshold level has been exceeded for a burst period, e.g. 4s. After each burst has ended, the temperature discriminating unit 122 is reactivated and the process is repeated. It will be appreciated that the nozzle activation unit 124 is connected to the water supply (not shown) and each nozzle 108 so that control of the water mist can be achieved.

Although two temperature discriminating units 114, 122 are shown, it will be understood that a single unit could be utilised to sense/detect the temperature exceeding one or more threshold or trigger levels.

It will be appreciated that the threshold or trigger levels utilised in the temperature discriminating units 114, 122 may be the same or may be different in accordance with a particular application.

In accordance with the present invention, the fastener arrangement 10 can be implemented in the fire detection system of FIG. 8 and the fire detection and suppression system of FIG. 10.

The fastener arrangement 10 has the advantage of combining a cargo bay liner panel fastener with a temperature sensor. Because of its modular construction, different bolt assemblies, nut assemblies and sensor assemblies can be combined for different applications. The optional provision of the light pipe allows a maintenance engineer or the like to determine whether the sensor is operating properly or not when they are in the compartment or in situ according to the particular application.

Advantageously, fire detection false alarm rates can be improved using the fastener arrangement of the present invention by providing two layer protection.

The fastener arrangement of the present invention is simple, robust and is compatible with existing fasteners. Moreover, the arrangement is easy to assemble, is of low cost both in manufacturing and maintenance.

1. A temperature sensing device comprising:
a bolt assembly;
a nut assembly mountable on the bolt assembly;
a sensor assembly located within the bolt assembly; and
a processing assembly located within the nut assembly, the processing assembly being connectable to the sensor assembly to process signals generated by the sensor assembly in response to temperature.

2. A device according to claim 1, wherein the processing assembly includes an electronics module and means for connecting the electronics module to a remote control unit.

3. A device according to claim 2, wherein the electronics module is capable of storing a unique identification code for the device.

4. A device according to claim 3, wherein the unique identification code is determined in accordance with the location of the device with respect to a reference position.

5. A device according to claim 1, wherein the processing assembly includes at least one indicator unit connected to the electronics module for indicating the operational status of the device.

6. A device according to claim 5, wherein said at least one indicator unit comprises a light emitting diode.

7. A device according to claim 6, wherein two light emitting diodes are present, one green and one red.

8. A device according to claim 5, wherein the sensor assembly comprises a sensor element having a connector portion for connecting with the processing assembly.

9. A device according to claim 8, wherein the sensor element comprises a thermocouple.

10. A device according to claim 8, wherein the sensor element comprises a semiconductor temperature sensing element.

11. A device according to claim 8, wherein the sensor element is mounted in a sheath within the bolt assembly.

12. A device according to claim 11, wherein the sheath comprises a light pipe which transmits light from said at least indicator unit to an external surface of the device.

13. A device according to claim 12, wherein the external surface of the device comprises a head portion of the bolt assembly.

14. A fire detection system comprising:
at least one first detector for detecting the presence of smoke;
at least one second detector for detecting the presence of elevated temperatures; and
processing means connected each of said at least one first and second detectors for receiving signals therefrom indicative of the presence of smoke and elevated temperatures respectively, and for producing an indication of the presence of a fire;
characterized in that each of said second detector means comprises a temperature sensing device according to claim 1.

15. A system according to claim 14, wherein the processing means includes first comparison means for determining if the signals from said at least one first detector exceeds a first predetermined threshold, and second comparison means for determining if the signals from said at least one second detector exceeds a second predetermined threshold, the second comparison means being enabled by an output signal from the first comparison means when the first predetermined threshold is exceeded and produces the indication of the presence of a fire when the second predetermined threshold has been exceeded.

16. A fire suppression system comprising:
a fire detection system according to claim 14;
fire suppression means for suppressing a fire;
control means for controlling the fire suppression means once a signal corresponding to the indication of the presence of the fire has been input.

17. A system according to claim 16, wherein the control means includes comparison means connectable to said at least one second detector for receiving signals therefrom, the comparison means determining if a predetermined threshold has been exceeded and provides control signal for operating the fire suppression means.

18. A system according to claim 17, wherein the comparison means receives signals from a plurality of second detectors whose signals have exceeded the second threshold in the second comparison means and provides control signals for the fire suppression means in the locality of said plurality of second detectors.

19. A system according to claim 16, wherein the fire suppression means comprises a water mist system utilising a plurality of nozzles.

20-22. (canceled)
